(19) United States
(12) Patent Application Publication
(10) Pub. No.: US 2020/0250722 A1
(43) Pub. Date: Aug. 6, 2020

(54) Product Content Processing Methods, Apparatuses, Storage Media, and Processing Devices

(71) Applicant: Alibaba Group Holding Limited, Grand Cayman (KY)

(72) Inventors: Yingying Yan, Hangzhou (CN); Yuan HE, Beijing (CN)

(21) Appl. No.: 16/778,560

(22) Filed: Jan. 31, 2020

(30) Foreign Application Priority Data
Feb. 2, 2019 (CN) 201910107564.8

(51) Int. Cl. G06Q 30/06; G06Q 20/12

(52) U.S. Cl. CPC G06Q 30/0621; G06Q 30/0641; G06Q 30/0629; G06Q 20/12

(57) ABSTRACT

A method, an apparatus, a storage medium, and a processor for processing product content are disclosed. The method includes: identifying design content of at least one partial portion of a product; and identifying at least one feature that is similar to a predetermined design content from the design content of the partial portion of the product; and obtaining at least one alternative content based on the at least one identified feature that is similar to the predetermined design content. The present disclosure solves the technical problems that an entire design content detection cannot accurately know specific positions of a design content of a product that are similar to an existing design content in related technologies.

### CROSS REFERENCE TO RELATED PATENT APPLICATIONS

This application claims priority to Chinese Application No. 201910107564.8, filed on 2 Feb. 2019 and entitled “Product Content Processing Methods, Apparatuses, Storage Media, and Processing Devices,” which is hereby incorporated by reference in its entirety.

### TECHNICAL FIELD

The present disclosure relates to the field of data processing, and particularly to product content processing methods, apparatuses, storage media, and processing devices.

### BACKGROUND

It is common in the market to authorize an entire design content of a product, i.e., to perform an authorization of the entirety of the design content solution of the product. An authorized user needs to pay a certain usage fee to a party which provides the authorization. Therefore, testing an entire design content of a product in the usual inspection cannot accurately obtain and understand specific similar positions of the design content of the product and existing design content. Furthermore, the cost of authorization for an entire authorization of a product is relatively high. In addition, in the field of original design content, before devoting certain effort for designing a product, a designer cannot know the degree of innovation of design content thereof, whether the design content involves design content of other persons, or whether the design content infringes any existing design content. In the case of examining and finding that the design content infringes an existing design content, the designer needs to modify the design content until it is significantly different from the existing design content that is infringed to ensure that it will not cause an infringement on the existing design content. For relatively similar design content and existing design content, the designer needs to put more effort on designing content multiple times to ensure originality and innovation, and not to infringe any existing design content.

In view of the above problems, no effective solution has been proposed.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

Embodiments of the present disclosure provide a method, an apparatus, a storage medium, and a processing device for processing product content, so as to at least solve technical problems that an entire design content detection in related technologies cannot accurately know specific similar positions of a design content of a product with an existing design content.

In implementations, a method for processing product content is provided, and includes: identifying design content of at least one partial portion of a product; and identifying at least one feature that is similar to a predetermined design content from the design content of the partial portion of the product; and obtaining at least one alternative content based on the at least one identified feature that is similar to the predetermined design content.

In implementations, a method for processing product content is also provided, and includes: displaying design content of at least one partial portion of a product; and displaying at least one feature image of the design content of the partial portion of the product that is similar to a predetermined design content; and displaying an alternative content corresponding to the at least one feature image that is similar to the predetermined design content.

In implementations, a data processing method is further provided, and includes: obtaining first image data; obtaining second image data of at least one part of the first image data; obtaining at least one feature of the second image data that is similar to a predetermined content; obtaining at least one third image data based on the at least one feature; and using the third image data to replace the second image data to generate resulting data.

In implementations, a product content processing apparatus is further provided, and includes: a first identification module used for identifying design content of at least one partial portion of a product; a second identification module used for identifying at least one feature that is similar to a predetermined design content from the design content of the partial portion of the product; and an acquisition module used for obtaining at least one alternative content based on the at least one identified feature that is similar to the predetermined design content.

In implementations, a product content processing apparatus is further provided, and includes: a first display module used for displaying design content of at least one partial portion of a product; a second display module used for displaying at least one feature image of the design content of the partial portion of the product that is similar to a predetermined design content; and a third display module used for displaying an alternative content corresponding to the at least one feature image that is similar to the predetermined design content.

In implementations, a storage medium is also provided. The storage medium includes a stored program, wherein the program, when being run, controls a device where the storage medium is located to perform any one of the foregoing methods.

In implementations, a processing device is further provided. The processing device is configured to run a program, wherein the program performs any one of the foregoing methods when being run.

In the embodiments of the present disclosure, by identifying a design content of a partial portion of a product, and the design content of the partial portion of the product is compared with a partial portion of an existing design content or the entire existing design content. At least one feature that is similar to a predetermined design content is identified from the design content of the partial portion of the product. Based on the at least one identified feature that is similar to the predetermined design content, at least one alternative content is obtained. An existing design to which the alternative content belongs is an authorizer, and the product is an authorized party. By identifying and detecting respective design contents of partial portions of a design content, the purpose of a well-directed replacement of a design content of a partial portion of a product that is similar to a partial portion of an existing design is achieved. Therefore, by detecting a design content of a partial portion of a product design content, the technical effects of accurately obtaining specific similar position(s) of the product design content with respect to an existing design content can be achieved, thus solving the technical problems that an entire design content detection cannot accurately know specific positions of a design content of a product that are similar to an existing design content in related technologies.

### BRIEF DESCRIPTION OF THE DRAWINGS

The drawings described herein are used to provide a further understanding of the present disclosure, and constitute a part of the present application. The schematic embodiments of the present disclosure and the descriptions thereof are used to explain the present disclosure, and do not constitute an improper limitation on the present disclosure. In the drawings:

FIG. 1 shows a block diagram of a hardware structure of a computer terminal (or a mobile device) for implementing a product content processing method.

FIG. 2 is a flowchart of a method for processing product content according to a first embodiment of the present disclosure.

FIG. 3 is a schematic diagram of design content of a partial portion of a product according to the first embodiment of the present disclosure.

FIG. 4 is a flowchart of a method for processing product content according to a second embodiment of the present disclosure.

FIG. 5 is a flowchart of a data processing method according to a third embodiment of the present disclosure.

FIG. 6 is a schematic diagram of an apparatus for processing product content according to a fourth embodiment of the present disclosure.

FIG. 7 is a schematic diagram of an apparatus for processing product content according to a fifth embodiment of the present disclosure.

FIG. 8 is a structural block diagram of a computer terminal according to a sixth embodiment of the present disclosure.

### DETAILED DESCRIPTION

In order to enable one skilled in the art to better understand the content of the present disclosure, the technical content in the embodiments of the present disclosure will be described clearly and completely hereinafter in conjunction with the accompanying drawings of the embodiments of the present disclosure. Apparently, the described embodiments represent merely some and not all of the embodiments of the present disclosure. Based on the embodiments of the present disclosure, all other embodiments obtained by one of ordinary skill in the art without making any creative effort should fall within the scope of protection of the present disclosure.

It should be noted that the terms “first” and “second”, etc., in the specification and claims of the present disclosure and the above accompanying drawings are used to distinguish similar objects, and are not necessarily used to describe a specific order or sequence. It should be understood that data used in this way is interchangeable whenever appropriate, so that the embodiments of the present disclosure described herein can be implemented in orders other than those illustrated or described herein. Furthermore, the terms “containing”, “having”, and any variations thereof are intended to cover a non-exclusive inclusion. For example, a process, method, system, product, or device that contains a series of operations or units need not be limited to those explicitly listed, and may include other operations or units not that are explicitly listed or inherent to such process, method, product or device.

### First Embodiment

According to the embodiments of the present disclosure, a method embodiment of a method for processing product content is also provided. It should be noted that operations shown in a flowchart of the accompanying drawings can be executed in a computer system such as a set of computer-executable instructions. Furthermore, although a logical order is shown in a flowchart, in some cases, operations may be performed in an order that is different from the one that is shown or described.

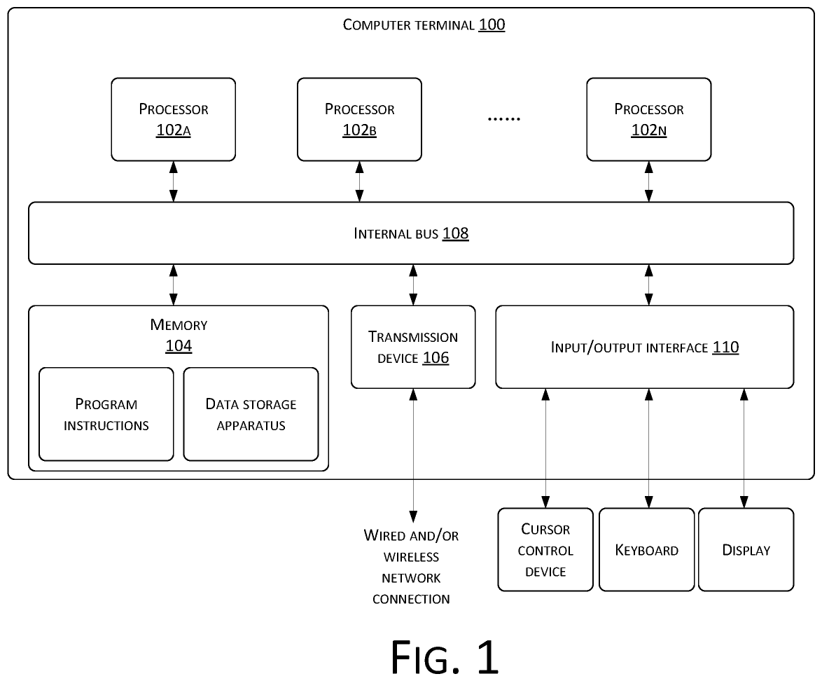

The method embodiment provided in the first embodiment of the present application may be executed in a mobile terminal, a computer terminal, or a similar computing device. FIG. 1 shows a block diagram of a hardware structure of a computer terminal 100 (or a mobile device 100) for implementing a method of processing product content. As shown in FIG. 1, the computer terminal 100 (or the mobile device 100) may include one or more (102a, 102b, . . . , 102n shown in the figure) processors 102 (the processor 102 may include, but is not limited to, a processing device such as a microcomputer MCU, or a programmable logic device FPGA, etc.), memory 104 for storing data, and a transmission device 106 for communication functions. In implementations, the computer terminal 100 may also include an internal bus 108, an input/output interface (I/O interface) 110, a universal serial bus (USB) port (which may be included as one of the ports of the I/O interface), and a network interface (which may be a part of the transmission device 106). In implementations, the computer terminal 100 may also include a display, a power supply, and/or a camera. One of ordinary skill in the art can understand that the structure shown in FIG. 1 is only schematic, and does not impose any limitations on the structure of the above electronic device. For example, the computer terminal 100 may further include more or fewer components than those shown in FIG. 1, or have a configuration different from the one shown in FIG. 1.

It should be noted that the one or more processors 102 and/or other data processing circuits described in the present text may generally be referred to as “data processing circuits” herein. The data processing circuit may be fully or partially embodied as software, hardware, firmware, or any other combination thereof. In addition, the data processing circuit may be a single independent processing module, or may be wholly or partially incorporated into any one of the other elements in the computer terminal 100 (or the mobile device). As involved in the embodiments of the present application, the data processing circuit is used as a processor control (for example, a selection of a variable resistance terminal path connected to an interface).

The memory 104 may be configured to store software programs and modules of application software, such as program instruction(s)/data storage device(s) corresponding to a product content processing method in the embodiments of the present disclosure. The processor(s) 102 perform(s) various functional applications and data processing by running software program(s) and module(s) stored in the memory 104, i.e., implementing the product content processing method of the application program. The memory 104 may include a high-speed random access memory, and may further include a non-volatile memory, such as one or more magnetic storage devices, a flash memory, or other non-volatile solid-state memory. In some examples, the memory 104 may further include storage devices remotely disposed with respect to the processor(s) 102, and these remote storage devices may be connected to the computer terminal 100 through a network. Examples of the network include, but are not limited to, the Internet, an intranet, a local area network, a mobile communication network, and a combination thereof.

The transmission device is configured to receive or transmit data via a network. A specific example of the network may include a wireless network provided by a communication provider associated with the computer terminal 100. In an example, the transmission device includes a network adapter (Network Interface Controller, NIC), which can be connected to other network devices through a base station so as to conduct communications with the Internet. In an example, the transmission device may be a radio frequency (RF) module, which is used to conduct communications with the Internet in a wireless manner.

The display may be, for example, a liquid crystal display (LCD) of a touch screen type. The liquid crystal display may enable a user to interact with a user interface of the computer terminal 100 (or the mobile device).

It should be noted that, in some optional embodiments, the computer device (or the mobile device) as shown in FIG. 1 and described above may include hardware elements (including circuits) and software elements (including computer codes stored on a computer-readable medium), or a combination of hardware and software elements. It should be noted that FIG. 1 is only an example of specific examples, and is intended to illustrate types of components that may be present in the computer device (or the mobile device) described above.

In some embodiments, the computer device (or the mobile device) as shown in FIG. 1 and described above has a touch display device (which is also referred to as a “touch screen” or a “touch display”). In some embodiments, the computer device (or the mobile device) as shown in FIG. 1 and described above has a graphical user interface (GUI). A user can perform human-computer interactions with the GUI by making finger contacts and touching on a touch-sensitive surface and/or hand gestures, Here, human-computer interaction functions in implementations include the following interactions: creating a web page, drawing, word processing, producing an electronic document, a game, a video conference, an instant messaging, sending and receiving emails, calling an interface, playing a digital video, playing a digital music, and/or web browsing, etc. Executable instructions, which are used for performing the human-computer interaction functions, are configured and/or stored in a computer program product or a readable storage medium that is executable by one or more processors.

With the increasing strength of the protection of intellectual property rights, in some cases where content of a product design needs to be monitored and tested, a determination of whether the content of the product design infringes or is suspected of infringing content of an existing design needs to be performed. For example, in a product design competition, each participating product design needs to be tested to ensure the originality of the respective participating product design. For another example, in the online mall, a merchant of a new product needs to monitor and test whether the new product infringes or is suspected of infringing content of an existing product design, in order to prevent the merchant and a platform from suffering losses, and to ensure that the merchant with bad intentions from making illegal profits.

In related technologies, the entire design content of a product is usually tested to determine whether the entire design content of the product infringes an existing design content. However, the design content of a product often includes a large number of design elements and design contents. Only performing design content monitoring of the design content of the product to determine whether the product infringes an existing design content not only has a low accuracy rate, but also fails to accurately know specific similar positions of the design content of the product with respect to the existing design content when the design content of the product is attached to the existing design content.

The present embodiment adopts a method for processing product content that checks a design content of a partial portion of a product design content, and may include the following operations:

firstly identifying a design content of at least a partial portion of a design content of a product;

identifying whether the identified design content of the partial portion of the product is similar to at least one existing predetermined design content through a recognition algorithm;

determining at least one alternative content based on the at least one existing predetermined design content that is similar to the design content of the partial portion in response to identifying that the design content of the partial portion of the product is similar to the at least one existing predetermined design content;

recommending the at least one alternative content to a user;

selecting a target alternative content from the at least one alternative content in response to an action of selection from the user;

sending a payment request corresponding to the target alternative content to the user; and

replacing the design content of the partial portion with the target alternative content when a payment associated with the payment request is successfully made.

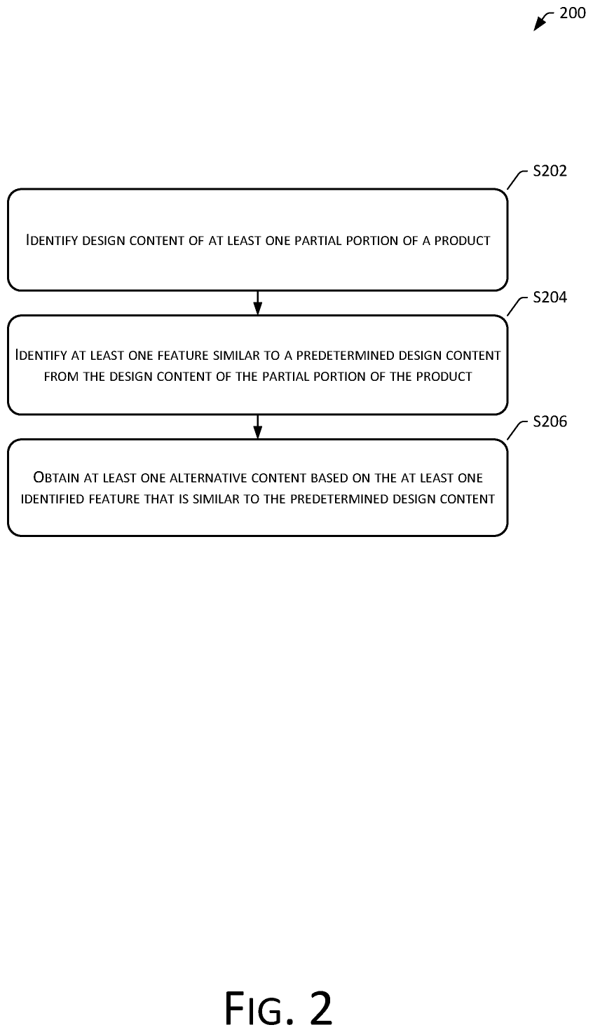

Under the above operating environment, the present application provides a method for processing product content as shown in FIG. 2. FIG. 2 is a flowchart of a method 200 for processing product content according to a first embodiment of the present disclosure. As shown in FIG. 2, the method 200 may include the following operations.

S202: Identify design content of at least one partial portion of a product.

In implementations, the design content of the product may be a shape, a style, a color, an art word, etc. of the product, or may be a trademark, an identification, etc., or a combination of the aforementioned content.

In implementations, identifying the design content of the at least one partial portion of the product may include first identifying an entire design content of the product, and then identifying the design content of the at least one partial portion from the entire design content. The design content of the partial portion is a constituent part of the entire design content, and may be a part of the entire design content.

In implementations, identifying the design content of the at least one partial portion of the product may also include directly setting partial portions that need to be identified on the product. A design content of at least one partial portion may be preset by a user, and thereby the design content of the at least one partial portion may be identified. The identified design content of the at least one partial portion is then selected and processed.

In implementations, the design content of the partial portion may be duplicated units of multiple design contents that are repeated. For example, for a superimposed star pattern on a short sleeve, a design content of such partial portion may be a single star pattern. Alternatively, the design content of the partial portion may be a more prominent identification. For example, for a heart-shaped image on a solid-colored short sleeve, a design content of such partial portion may be the heart-shaped image. Alternatively, the design content of the partial portion may be part of a more complicated image. For example, for a key-shaped graphic in a complex pattern on clothes, and a design content of such partial portion may be a key-shaped image.

In implementations, identifying the design content of the at least one partial portion of the product may be performed by a recognition algorithm. A recognition algorithm model is trained using training data, and the training data includes design content of products and respective design contents of various partial portions of the products.

In implementations, identifying the design content of the at least one partial portion of the product may be performed may be performed through feature extraction. For example, graphical features of a product design drawing are extracted to achieve an extraction of respective design contents of partial portions of a product from an entire design content of the product.

S204: Identify at least one feature similar to a predetermined design content from the design content of the partial portion of the product.

In implementations, the predetermined design content is an existing design content. The existing design content may be stored in a database, and the predetermined design content may be a preset existing design content, so as to implement inspection and comparison according to user requirements to determine whether the design content of the partial portion of the product is similar to the predetermined design content.

In implementations, the number of the predetermined design contents may be one or more. The number of predetermined design contents similar to the design content of the partial portion of the product may be one or more. The number of features of the predetermined design content similar to the design content of the partial portion of the product may be one or more. The number of design contents of the partial portion similar to the predetermined design content may be one or more.

In implementations, for the design content of the partial portion of the product being similar to the predetermined design content, the design content is determined to be similar to the predetermined design content when a degree of similarity between the design content and the predetermined design content reaches a preset threshold.

In implementations, identifying the at least one feature similar to the predetermined design content from the design content of the partial portion of the product may be performed through a recognition algorithm. A recognition algorithm model is trained using training data, and the training data includes design contents of partial portions of products and predetermined design contents that are similar thereto.

S206: Obtain at least one alternative content based on the at least one identified feature that is similar to the predetermined design content.

In implementations, the number of design contents of the partial portion of the product may be one or more, and the number of features corresponding to the predetermined design content may be one or more. For a design content of a partial portion of each product, at least one alternative content is obtained through feature(s) of at least one predetermined content corresponding thereto.

In implementations, the alternative content is used for replacing the design content of the partial portion of the product. The predetermined design content to which the alternative content belongs is an authorizer, and the design content of the product is an authorized party. The authorized party of the product pays the authorizer, and the design content of the product is authorized to use the alternative content.

In implementations, the number of alternative contents may be one or more. When multiple alternative contents exist, the user may select one alternative content from the multiple alternative content for replacement.

Using the above operations, a method of using a design content of a partial portion of a product is used, and the design content of the partial portion of the product is compared with a design content of a partial portion of an existing design content or an entire design content of the existing design content. At least one feature similar to a predetermined design content is identified from the design content of the partial portion of the product is compared. At least one alternative content is obtained based on the at least one identified feature similar to the predetermined design content. An existing design to which the alternative content belongs is an authorizer, and the product is an authorized party. By identifying and detecting respective design contents of partial portions of a design content, the purpose of a well-directed replacement of a design content of a partial portion of a product that is similar to a partial portion of an existing design is achieved. Therefore, by detecting a design content of a partial portion of a product design content, the technical effects of accurately obtaining specific similar position(s) of the product design content with respect to an existing design content can be achieved, thus solving the technical problems that an entire design content detection cannot accurately know specific similar positions of a design content of a product with an existing design content in related technologies.

In implementations, the method further includes: recommending the alternative content; and selecting a target alternative content from the at least one alternative content, and using the target alternative content to replace the design content of the partial portion.

At least one alternative content is obtained based on the at least one identified feature similar to the predetermined design content, and is recommended to a user, to allow the user to decide whether to replace the design content of the partial portion in the design content of the product with the alternative content, or to allow the user to decide which alternative content is to replace the design content of the partial portion in the design content of the product.

In implementations, the number of the alternative contents may be one or more. When the number of the alternative contents is more than one, the user may select a target alternative content from multiple alternative contents, and the design content of the partial portion of the product is replaced according to the target alternative content.

In implementations, the target alternative content may be selected by the user. Alternatively, an alternative content having the highest degree of similarity with the design content of the partial portion of the product may be automatically selected as the target alternative content.

In implementations, prior to replacing the design content of the partial portion with the target replacement content, the method further includes: sending a payment request; and replacing the design content of the partial portion with the target replacement content when a payment associated with the payment request is successfully made.

In implementations, prior to replacing the design content of the partial portion with the target replacement content, a payment request may be sent. The payment request may be a payment link with a payment function, and a jump to a payment interface may be performed according to the payment link, or a payment page with a payment function may be entered directly, or a payment function included in the interface may be triggered to enter into a payment page, etc. After a payment associated with the payment request is successfully made, for example, a payment is successfully made in a payment page, or a payment is successfully made through a payment link, etc., the method of sending the payment request automatically jumps back to a page before the payment, and changes a payment status, to realize displaying a price to the user while ensuring that the user is authorized to use the target alternative content only after paying the fee.

It should be noted that the usage fee of different alternative target contents may be different and can be configured. An evaluation can be performed according to parameters such as an amount of usage, the number of clicks, the number of views, and the popularity, etc., to determine different usage fees for different target alternative contents.

In implementations, after the user makes a successful payment in the above payment interface, the payment interface is jumped and returned to the original interface. In this interface, the design content of the partial portion in the design content of the product can be replaced with the target alternative content.

In implementations, identifying the at least one feature similar to the predetermined design content from the design content of the partial portion of the product includes: comparing the design content of the partial portion with design feature(s) of the predetermined design content; determining that the design content of the partial portion is similar to the predetermined design content when a degree of similarity between the design content of the partial portion and the design feature(s) of the predetermined design content exceeds a preset threshold; and identifying at least one feature similar to the predetermined design content from the design content of the at least one partial portion of the product.

In implementations, when at least one feature similar to the predetermined design content is identified from the design content of the partial portion of the product, the design content of the partial portion of the product may be compared with feature(s) of the predetermined design content. When a degree of similarity between the design content of the partial portion and the design feature(s) of the predetermined design content exceeds a preset threshold, a determination is made that the design content of the partial portion is similar to the predetermined design content.

In implementations, when the design content of the partial portion of the identified product is determined to be similar to the feature(s) of the predetermined design content, the user can make an appeal, and a reviewer conducts a manual review. After the manual review, a usage fee may not be paid or a replacement may not be performed if the design content is determined to be original and novel.

It should be noted that, by repeatedly performing the above operations, degrees of similarity between features of a design content of a partial portion and different predetermined design contents are determined, and degrees of similarity between features of different partial portions of a product and respective predetermined design contents are determined.

In implementations, when a degree of similarity between the design content of the partial portion and the design feature(s) of the predetermined design content does not exceed the preset threshold, a determination is made that the design content of the partial portion is original and novel. The design content of the partial portion is added to a traceable database used for storing predetermined design contents.

In implementations, the design content of the partial portion whose degree of similarity with the design feature(s) of the predetermined design content does not exceed the preset threshold is deemed to be original and novel design content. The design content having the originality and novelty may be reclassified as content having non-originality after manual review. The user has a means of submitting an appeal.

In implementations, the design content of the partial portion having the originality and novelty may be stored in an only traceable database, and the design content of the partial portion having the originality and novelty may be treated as an existing design content.

In implementations, the at least one feature similar to the predetermined design content is identified from the design content of the partial portion of the product through a recognition algorithm. The design content of the partial portion includes at least one of the following: a pattern, a style, a shape, a color, a text, and a combination thereof.

In implementations, the design content of the partial portion includes at least one of the following: a pattern, a style, a shape, a color, a text, and a combination thereof. The combination thereof is a combination of at least two of the pattern, the style, the shape, the color, and the text, for example, a combination of the pattern and the style, or a combination of the shape, the color, and the text.

In implementations, identifying the at least one feature similar to the predetermined design content from the design content of the partial portion of the product includes: marking the design content of the partial portion on the design content; and displaying mark(s).

In implementations, after identifying the at least one feature similar to the predetermined design content from the design content of the partial portion of the product, the design content of the partial portion may be marked on the design content, and a mark thereof may be displayed, to mark a position of the partial portion of the design content that is similar to the predetermined design content for the user.

In implementations, a position of the partial portion may be marked by sending position information of the partial portion to the user, to allow the user to be able to know the position of the partial portion whose design content is similar to the predetermined design content.

In implementations, the alternative content belongs to predetermined design contents, and the predetermined design contents are stored in a predetermined database.

In implementations, the alternative content is a design content of an authorizer or a design feature of the design content. Therefore, the alternative content belongs to the predetermined design contents, and may be one or more of the predetermined design contents.

In implementations, the predetermined database may be a data traceable database.

It should be noted that the present embodiment also provides a method for processing a partially similar product design as an optional implementation of the present embodiment, and such implementation is described in detail below.

In this implementation, a similarity between a product and an existing design is identified through an algorithm, and a user is clearly informed of position(s) of portion(s), so that the user can clearly guide a portion that needs to be modified. At the same time, the user is given at least one alternative design that others can provide authorization, to help the user to quickly solve a similar portion, improve performance, and ensure the innovation of the product. On the other hand, the algorithm can identify a portion of the product having an original and novel design, which is added to an alternative design library. In an entire mode, a designer pays a certain license fee for using the design, and can also obtain a certain license fee if a design thereof in the alternative design library is used by other persons.

The related technologies do not have any method for comparing partial designs of products and providing alternative solutions through algorithms. A more common one is an authorization of an entire product design content. A disadvantage is that an authorization fee of an authorization of an entire product is relatively high. Moreover, for an original designer, more effort needs to be invested in multiple designs to ensure originality and innovation if no replacement solution exists.

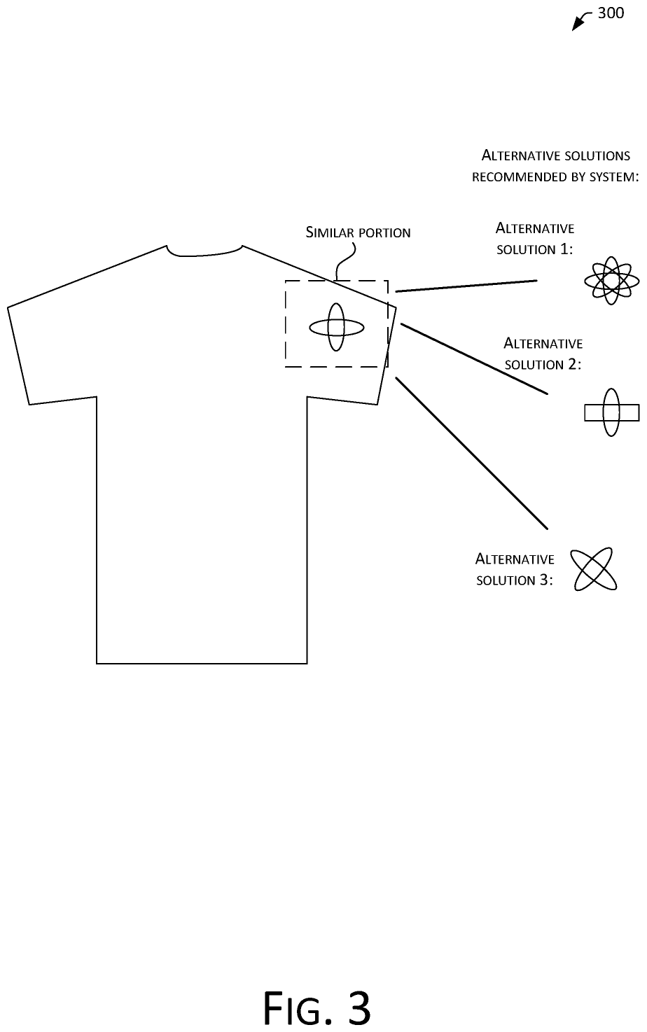

This solution solves the similarity of partial portions of product designs, and the method is applicable to various categories of products. A garment is used as an example case. FIG. 3 is a schematic diagram of design content of a partial portion of a product 300 according to the first embodiment of the present disclosure. As shown in FIG. 3, if an algorithm analyzes and marks that a pattern on a sleeve of the garment is similar to an existing design, and a system provides multiple alternative solutions that are source traceable. A merchant performs a selection, obtains an authorization for use, and pays a certain fee.

A method for solving partial similarity in product design in the present implementation specifically includes: identifying parts of products having a similar design by an algorithm; recommending an alternative design by a system according to features of the similar design parts; and using the alternative design and paying a certain fee by a merchant.

The similar design identified by the algorithm may be a pattern, a style, or a combination of the style and the pattern.

The parts of the products recognized by the algorithm to have the similar design may be one or more.

The algorithm marks the identified parts having the similar design and displays thereof a the user.

The alternative design recommended by the system is an existing public domain design.

The alternative design recommended by the system is a design library that is source traceable.

A charge mode of this solution may be a one-time charge or a monthly membership.

A payment method of the alternative design that is used may be a commission or a one-time authorization.

This algorithm is used to identify parts having original and novel designs and add these parts into an alternative design library.

In this implementation, a similarity between a product and an existing design is identified through an algorithm, and a user is clearly informed of position(s) of portion(s), so that the user can clearly guide a portion that needs to be modified. At the same time, the user is given at least one alternative design that others can provide authorization, to help the user to quickly solve a similar portion, improve performance, and ensure the innovation of the product.

### Second Embodiment

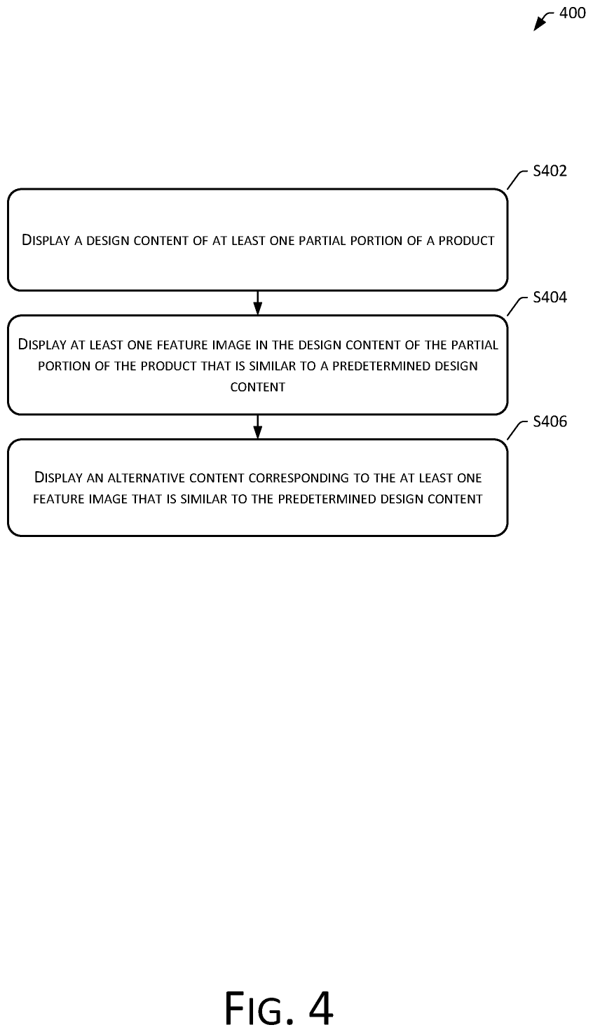

According to another aspect of the embodiments of the present disclosure, a method for processing product content is also provided. FIG. 4 is a flowchart of a method 400 for processing product content according to a second embodiment of the present disclosure. As shown in FIG. 4, the method 400 may include the following operations.

S402: Display a design content of at least one partial portion of a product.

In implementations, identifying the design content of the at least one partial portion of the product may include first identifying an entire design content of the product, and then identifying the design content of the at least one partial portion from the entire design content. The design content of the partial portion is a constituent part of the entire design content, and may be a part of the entire design content.

In implementations, identifying the design content of the at least one partial portion of the product may also include directly setting partial portions that need to be identified on the product. A design content of at least one partial portion may be preset by a user, and thereby the design content of the at least one partial portion may be identified. The identified design content of the at least one partial portion is then selected and processed.

In implementations, identifying the design content of the at least one partial portion of the product may be performed by a recognition algorithm. A recognition algorithm model is trained using training data, and the training data includes design content of products and respective design contents of various partial portions of the products.

S404: Display at least one feature image in the design content of the partial portion of the product that is similar to a predetermined design content.

In implementations, the predetermined design content is an existing design content. The existing design content may be stored in a database, and the predetermined design content may be a preset existing design content, so as to implement inspection and comparison according to user requirements to determine whether the design content of the partial portion of the product is similar to the predetermined design content.

In implementations, the number of the predetermined design contents may be one or more. The number of predetermined design contents similar to the design content of the partial portion of the product may be one or more. The number of features of the predetermined design content similar to the design content of the partial portion of the product may be one or more. The number of design contents of the partial portion similar to the predetermined design content may be one or more.

In implementations, identifying the at least one feature similar to the predetermined design content from the design content of the partial portion of the product may be performed through a recognition algorithm. A recognition algorithm model is trained using training data, and the training data includes design contents of partial portions of products and predetermined design contents that are similar thereto.

S406: Display an alternative content corresponding to the at least one feature image that is similar to the predetermined design content.

In implementations, the number of design contents of the partial portion of the product may be one or more, and the number of features corresponding to the predetermined design content may be one or more. For a design content of a partial portion of each product, at least one alternative content is obtained through feature(s) of at least one predetermined content corresponding thereto.

In implementations, the alternative content is used for replacing the design content of the partial portion of the product. The predetermined design content to which the alternative content belongs is an authorizer, and the design content of the product is an authorized party. The authorized party of the product pays the authorizer, and the design content of the product is authorized to use the alternative content.

In implementations, the number of alternative contents may be one or more. When multiple alternative contents exist, the user may select an alternative content from the multiple alternative content for replacement.

Using the above operations, a method of using a design content of a partial portion of a product is used, and the design content of the partial portion of the product is compared with a design content of a partial portion of an existing design content or an entire design content of the existing design content. At least one feature similar to a predetermined design content is identified from the design content of the partial portion of the product is compared. At least one alternative content is obtained based on the at least one identified feature similar to the predetermined design content. An existing design to which the alternative content belongs is an authorizer, and the product is an authorized party. By identifying and detecting respective design contents of partial portions of a design content, the purpose of a well-directed replacement of a design content of a partial portion of a product that is similar to a partial portion of an existing design is achieved. Therefore, by detecting a design content of a partial portion of a product design content, the technical effects of accurately obtaining specific similar position(s) of the product design content with respect to an existing design content can be achieved, thus solving the technical problems that an entire design content detection cannot accurately know specific similar positions of a design content of a product with an existing design content in related technologies.

In implementations, after displaying the alternative content corresponding to the at least one feature image that is similar to the predetermined design content, the method further includes: displaying a payment page of a target alternative content, wherein the alternative content corresponding to the at least one feature image is displayed; and displaying a design content after the design content of the partial portion is replaced with the target alternative content after a successful payment is made.

In implementations, prior to replacing the design content of the partial portion with the target alternative content, the method further includes: sending a payment request; and replacing the design content of the partial portion with the target alternative content when a payment associated with the payment request is successfully made. Before the design content of the partial portion of the product is replaced with the target alternative content, a payment request may be sent. The payment request can be a payment link. According to the payment link, a jump to a payment interface can be made to show a price to a user while ensuring that the target alternative content is authorized for use only after a payment is made.

It should be noted that usage fees of different target alternative contents can be different and can be set. An evaluation may be performed according to parameters such as an amount of usage, the number of clicks, the number of views, and the popularity to determine different usage fees for different target alternative contents.

### Third Embodiment

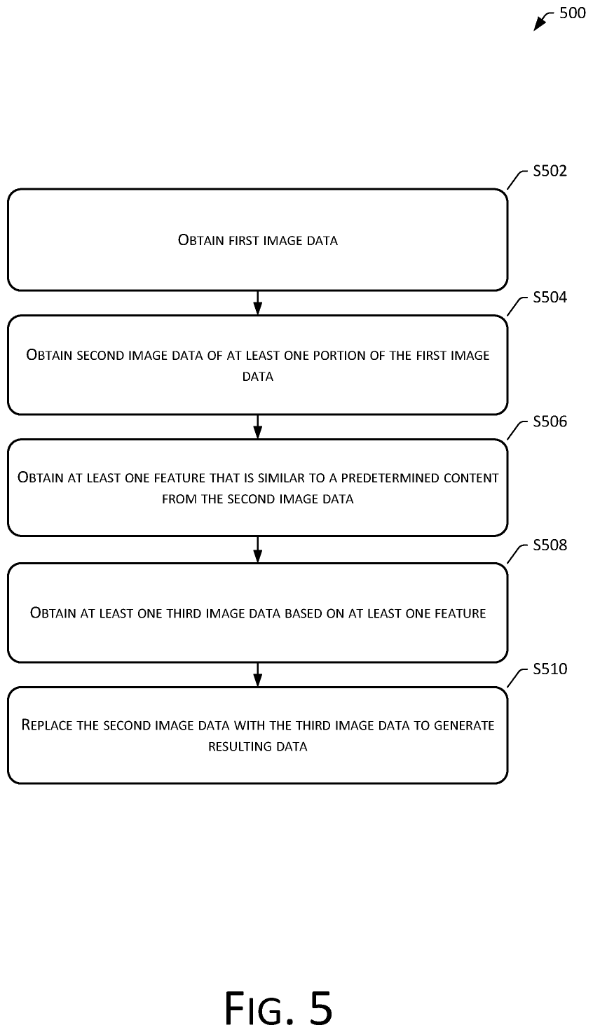

According to another aspect of the embodiments of the present disclosure, a method for processing product content is also provided. FIG. 5 is a flowchart of a method 500 for processing product content according to a third embodiment of the present disclosure. As shown in FIG. 5, the method 500 may include the following operations.

S502: Obtain first image data.

S504: Obtain second image data of at least one portion of the first image data.

S506: Obtain at least one feature that is similar to a predetermined content from the second image data.

S508: Obtain at least one third image data based on at least one feature.

S510: Replace the second image data with the third image data to generate resulting data.

In implementations, the first image data may be a target picture that needs to undergo a feature replacement. The target picture may include multiple features. The features may be text features, graphical features, color features, pattern features, etc., and may also be any combination of a text, a graphic, a color, or a pattern. The first data image may be first image data of the product.

In implementations, the second image data may be a partial image of the first image data. The second image data may include one or more features. For example, the first image data may include a picture of a front view of a short-sleeved product. The second image may be an image of a front view of the short-sleeved product at the chest position, and the second image data includes a text feature of “FIGHTING”.

In implementations, obtaining the second image data of the at least one portion of the first image data may include first identifying multiple features in the first image data through feature recognition, and determining an allocation of the multiple features to one or more partial images according to distances among the multiple features, or sizes and shapes of the partial images. It should be noted that, when multiple pieces of second image data of the portion of the first image data exists, the multiple pieces of the second image data may have different sizes and/or shapes.

In implementations, for obtaining the at least one feature that is similar to the predetermined content from the second image data, the predetermined content may be existing image data stored in a database. Prior to obtaining the at least one feature that is similar to the predetermined content from the second image data, a piece of image data is selected from a database as the pre-determined content according to a user selection or a fixed rule. The predetermined content may be a trademark, a template, etc.

In implementations, for obtaining the at least one third image data based on the at least one feature, one or more pieces of third image data whose degree of similarity with one or more features reaches a first preset threshold in units of features may be obtained. Alternatively, according to one or more features included in second image data in units of images, one or more pieces of third image data whose degree of similarity with the features and combinations of the features in the second image data reaches a second preset threshold are obtained.

In implementations, the third image data is used for replacing the second image data in the first image data. The third image data may be an image with security verification to ensure the security thereof, or may be an image with authorization certification to guarantee its rights, and can also be registered to guarantee its usage rights.

Through the above operations, by using a method of identifying second image data of a portion of first image data, the second image data of the portion of the first image data is compared with some or all of the portions of existing predetermined content. At least one feature that is similar to the predetermined content is identified from the second image data of the first image data. Based on the at least one identified feature that is similar to the predetermined content, at least one third image data is obtained. The third image data is an authorizer, and the first image data is an authorized party. By identifying and detecting features of a portion of first image data, the purpose of a targeted replacement of second image data of the portion that is similar to an existing predetermined content is achieved, thereby realizing the technical effects of accurately knowing a specific portion of the first image data that is similar to the existing predetermined content through a detection of the second image data of the portion of the first image data. In an event that the first image data is an image of a product, the technical problems of the related technologies that a detection of an entire design content fails to accurately specific positions of design contents of the product that are similar to those of an existing design.

In implementations, prior to obtaining the at least one feature that is similar to the predetermined content from the second image data, the method further includes: obtaining the predetermined content, wherein the predetermined content is stored in a database.

In implementations, the predetermined content may be stored in a database. Multiple predetermined contents may exist, and may be selected by user(s) or through fixed rule(s), for example, being changed according to an order of sizes, an order of times of storage, etc., in order to obtain the predetermined content.

In implementations, the predetermined content may be one piece, or may be a series of multiple related pieces.

It should be noted that the above data processing method can be applied to processing of a design content of a product. For example, a certain e-commerce platform determines whether a design content of a product is infringing. Specific operations may be as follows:

An e-commerce platform obtains predetermined contents, which are multiple LOGOs of a well-known trademark.

One or more main image data pieces of a target product are obtained, and processed sequentially. The above main image data pieces may be a front view of a jacket, a back view thereof, a six-sided view of a three-dimensional object, etc.

One image data piece of the main image data pieces of the target product is obtained and set as first image data.

Second image data of at least one portion of the first image data is obtained. For example, the product is a jacket, and image data of two portions (a font on a chest and a pattern on a sleeve in the image data) is obtained as second image data.

At least one feature of the second image data that is similar to a certain LOGO of the well-known trademark is obtained. For example, the pattern on the sleeve is similar to the shape of the logo of the well-known trademark.

The pattern on the sleeve in the second image data having a shape that is similar to at least one authorized LOGO is obtained and set as the at least one third image data.

The pattern on the sleeve of the product (the jacket) is replaced with the authorized logo to generate final main image data of a corresponding target product.

By recognizing the similarity between a product and an existing predetermined content, position(s) thereof is/are clearly informed to a user, to allow the user to clearly guide a portion that needs to be modified. At the same time, the user is given at least one alternative design that others can authorize to help the user to quickly resolve the similar portion, thus improving the efficiency, ensuring the product innovation, and avoiding product infringement and risks of being sued.

It should be noted that the foregoing method embodiments are all described as a series of action combinations for the sake of simple description. However, one skilled in the art should know that the present disclosure is not limited by the described orders of actions, because certain operations may be performed in other orders or in parallel according to the present disclosure. Moreover, one skilled in the art should also know that the embodiments described in the specification are all exemplary embodiments, and actions and modules involved therein may not be necessarily required by the present disclosure.

Through the description of the above embodiments, one skilled in the art can clearly understand that the methods according to the foregoing embodiments can be implemented by means of software plus a necessary universal hardware platform, and apparently may also be implemented by hardware. However, in many cases, the former is a better implementation. Based on such understanding, the essence of the technical content of the present disclosure, or the part that contributes to predetermined technologies can be embodied in a form of a software product. The computer software product is stored in a storage medium (such as ROM/RAM, a magnetic disk, or an optical disk), and includes a number of instructions to cause a terminal device (which may be a mobile phone, a computer, a server, or a network device, etc.) to execute each method described in the embodiments of the present disclosure.

### Fourth Embodiment

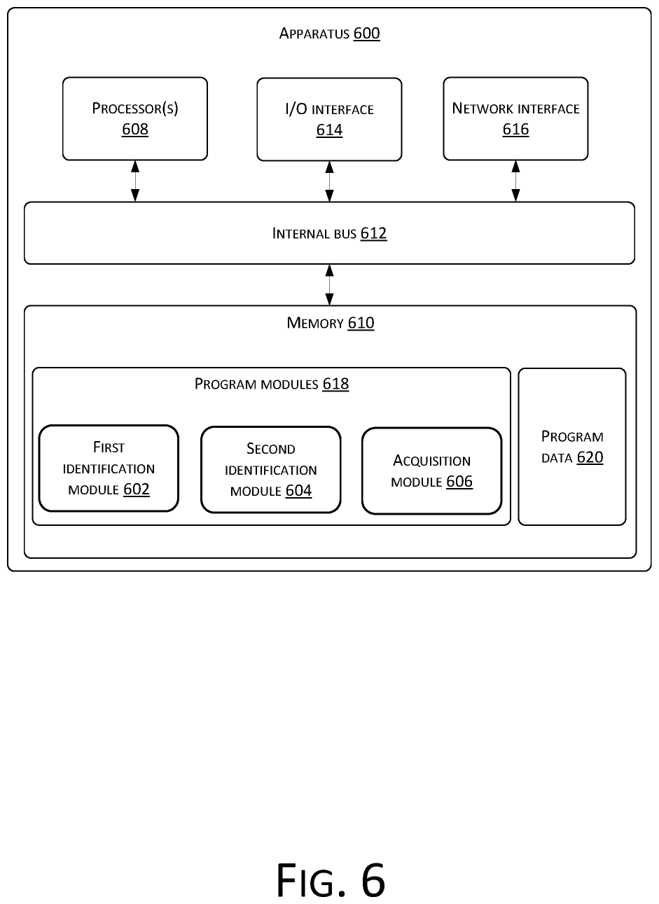

According to the embodiments of the present disclosure, a product content processing apparatus for implementing the first embodiment is also provided. FIG. 6 is a schematic diagram of an apparatus 600 for processing product content according to a fourth embodiment of the present disclosure. As shown in FIG. 6, the apparatus includes: a first identification module 602, a second identification module 64, and an acquisition module 66. The apparatus 600 is described in detail as follows.

The first identification module 602 is used for identifying design content of at least one partial portion of a product. The second identification module 604 is coupled to the first identification module 602, and is used for identifying at least one feature that is similar to a predetermined design content from the design content of the partial portion of the product. The acquisition module 606 is coupled to the second identification module 604, and is used for obtaining at least one alternative content based on the at least one identified feature that is similar to the predetermined design content.

In implementations, the apparatus 600 may further include one or more processors 608, memory 610, and an internal bus 612. In some implementations, the apparatus 600 may further include an input/output (I/O) interface 614, and a network interface 616.

The memory 610 may include a form of computer readable media such as a volatile memory, a random access memory (RAM) and/or a non-volatile memory, for example, a read-only memory (ROM) or a flash RAM. The memory 610 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 610 may include program modules 618 and program data 620. The program modules 618 may include one or more modules as described in the foregoing description and shown in FIG. 6.

It needs to note that the first identification module 602, the second identification module 604, and the acquisition module 606 correspond to operations S202 to S206 in the first embodiment. Examples and application scenarios implemented by the three modules are the same as corresponding operations, but are not limited to the content disclosed in the first embodiment. It should be noted that, the above modules, which act as a part of the apparatus, can be run in the computer terminal 100 provided in the first embodiment.

### Fifth Embodiment

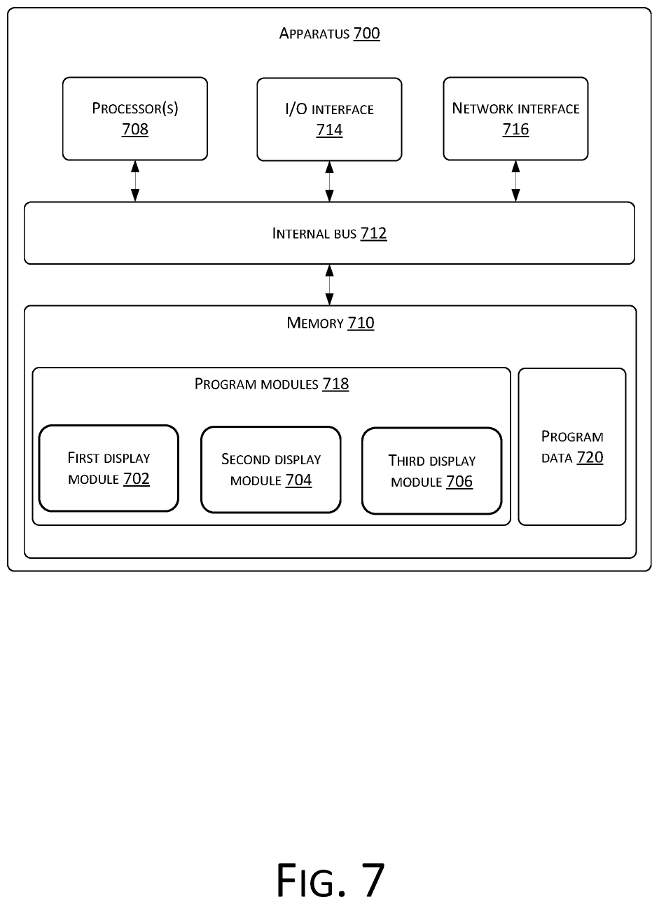

According to the embodiments of the present disclosure, a product content processing apparatus for implementing the second embodiment is also provided. FIG. 7 is a schematic diagram of an apparatus 700 for processing product content according to a fifth embodiment of the present disclosure. The apparatus includes: a first display module 702, a second display module 704, and a third display module 706. The apparatus 700 is described in detail as follows.

The first display module 702 is used for displaying design content of at least one partial portion of a product. The second display module 704 is coupled to the first display module 702, and is used for displaying at least one feature image of the design content of the partial portion of the product that is similar to a predetermined design content. The third display module 706 is coupled to the second display module 704, and is used for displaying an alternative content corresponding to the at least one feature image that is similar to the predetermined design content.

In implementations, the apparatus 700 may further include one or more processors 708, memory 710, and an internal bus 712. In some implementations, the apparatus 700 may further include an input/output (I/O) interface 714, and a network interface 716. The memory 710 may include a form of processor readable media as described in the foregoing description. In implementations, the memory 710 may include program units 718 and program data 720. The program units 718 may include one or more units as described in the foregoing description and shown in FIG. 7.

It needs to note that the first display module 702, the second display module 704, and the third display module 706 correspond to operations S402 to S406 in the second embodiment. Examples and application scenarios implemented by the three modules are the same as corresponding operations, but are not limited to the content disclosed in the second embodiment. It should be noted that, the above modules, which act as a part of the apparatus, can be run in the computer terminal 100 provided in the first embodiment.

Sixth Embodiment

The embodiments of the present disclosure may provide a computer terminal. The computer terminal may be any computer terminal device in a computer terminal group. In implementations, in implementations, the computer terminal may also be replaced with a terminal device such as a mobile terminal.

In implementations, in implementations, the computer terminal may be located in at least one network device among multiple network devices in a computer network.

In implementations, the computer terminal may execute program codes of the following operations in a content processing method of an application program: identifying design content of at least one partial portion of a product; and identifying at least one feature that is similar to a predetermined design content from the design content of the partial portion of the product; and obtaining at least one alternative content based on the at least one identified feature that is similar to the predetermined design content.

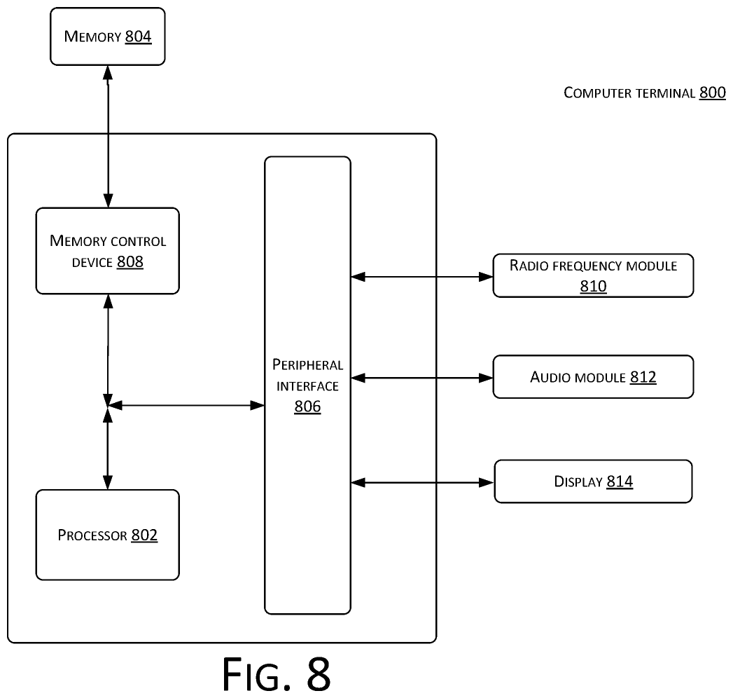

In implementations, FIG. 8 is a structural block diagram of a computer terminal according to a sixth embodiment of the present disclosure. As shown in FIG. 8, a computer terminal 800 may include one or more (only one is shown in the figure) processors 802, memory 804, and a peripheral interface 806. In implementations, the computer terminal 800 may further include a memory controller 808. In implementations, the computer terminal 800 may be associated or peripheral with a RF (radio frequency) module 810, an audio module 812, and a display 814.

The memory 804 can be configured to store software programs and modules, such as program instructions/modules corresponding to the methods and apparatuses for processing product content in the embodiments of the present disclosure. The processor(s) execute(s) various functional applications and data processing by running software programs and modules stored in the memory, i.e., implementing the methods for processing product content. The memory may include a high-speed random access memory, and may also include a non-volatile memory, such as one or more magnetic storage devices, a flash memory, or other non-volatile solid-state memory. In some examples, the memory may further include storage devices remotely located with respect to the processor(s). These remote storage devices may be connected to the terminal 10 through a network. Examples of the network include, but are not limited to, the Internet, an intranet, a local area network, a mobile communication network, and a combination thereof.

The processor(s) may call information and an application program stored in the memory through a transmission device to perform the following operations: identifying design content of at least one partial portion of a product; and identifying at least one feature that is similar to a predetermined design content from the design content of the partial portion of the product; and obtaining at least one alternative content based on the at least one identified feature that is similar to the predetermined design content.

In implementations, the processor(s) may further execute program codes of the following operations: the method further including: recommending alternative content(s); selecting target alternative content from at least one alternative content, and replacing the design content of the partial portion with the target alternative content.

In implementations, the processor(s) may further execute program codes of the following operations: prior to replacing the design content of the partial portion with the target alternative content, further including: sending a payment request; and replacing the design content of the partial portion with the target alternative content when a payment associated with the payment request is successfully made.

In implementations, the processor(s) may further execute program codes of the following operations: identifying at least one feature similar to the predetermined design content from the design content of the partial portion of the product comprising: comparing design features of the design content of the partial portion with design features of the predetermined design content; when a degree of similarity between the design features of the design content of the partial portion and the design features of the predetermined design content exceeds a preset threshold, determining that the design content of the partial portion is similar to the predetermined design content; and identifying at least one feature similar to the predetermined design content from the design content of the partial portion of at least one product.

In implementations, the processor(s) may further execute program codes of the following operations: determining that the design content of the partial portion is original when the degree of similarity between the design features of the design content of the partial portion and the design features of the predetermined design content does not exceed the preset threshold; and adding the original design content of the partial portion to a traceable database used for storing predetermined design contents.

In implementations, the processors may further execute program codes of the following operations: identifying at least one feature similar to the predetermined design content from the design content of the partial portion of the product through a recognition algorithm, wherein the design content of the partial portion includes at least one of a pattern, a style, a shape, a color, a text, and a combination thereof.

In implementations, the processors may further execute program codes of the following operations: after identifying the at least one feature that is similar to the predetermined design content from the design content of the partial portion of the product, including: making a mark on the design content of the partial portion in the design content; and displaying the mark.

In implementations, the processors may further execute program codes of the following operations: the alternative content belonging to predetermined design contents, and the predetermined design contents being stored in a predetermined database.

In implementations, the processors may further execute program codes of the following operations: displaying design content of at least one partial portion of a product; displaying at least one feature image of the design content of the partial portion of the product that is similar to a predetermined design content; and displaying alternative content corresponding to the at least one feature image that is similar to the predetermined design content.

In implementations, the processors may further execute program codes of the following operations: after displaying the alternative content corresponding to the at least one feature image that is similar to the predetermined design content, further including: displaying a payment page of a target alternative content, wherein the target alternative content is selected from the alternative content corresponding to the at least one feature image; and displaying a design content that is obtained after the design content of the partial portion is replaced with the target alternative content, upon a successful payment.

Using the embodiments of the present disclosure, a disclosure of a method for processing product content is provided. By identifying a design content of a partial portion of a product, and the design content of the partial portion of the product is compared with a partial portion of an existing design content or the entire existing design content. At least one feature that is similar to a predetermined design content is identified from the design content of the partial portion of the product. Based on the at least one identified feature that is similar to the predetermined design content, at least one alternative content is obtained. An existing design to which the alternative content belongs is an authorizer, and the product is an authorized party. By identifying and detecting respective design contents of partial portions of a design content, the purpose of a well-directed replacement of a design content of a partial portion of a product that is similar to a partial portion of an existing design is achieved. Therefore, by detecting a design content of a partial portion of a product design content, the technical effects of accurately obtaining specific similar position(s) of the product design content with respect to an existing design content can be achieved, thus solving the technical problems that an entire design content detection cannot accurately know specific similar positions of a design content of a product with an existing design content in related technologies.

One of ordinary skill in the art can understand that the structure shown in FIG. 8 is only schematic, and the computer terminal may also be a smart phone (such as an Android phone, an iOS phone, etc.), a tablet computer, a handheld computer, and a mobile Internet device (MID), a PAD, or other terminal device. FIG. 8 does not impose any limitations on the structure of the electronic device. For example, the computer terminal 100 may further include more or fewer components (such as a network interface, a display device, etc.) than those shown in FIG. 8, or have a configuration different from the one shown in FIG. 8.

One of ordinary skill in the art may understand that all or some of the operations in each method of the foregoing embodiments may be completed by instructing related hardware of a terminal device through a program. The program may be stored in a computer-readable storage medium, and the storage medium may include a flash disk, a read-only memory (ROM), a random access memory (RAM), a magnetic disk, or an optical disk, etc.

### Seventh Embodiment

The embodiments of the present disclosure also provide a storage medium. In implementations, in implementations, the storage medium may be configured to store program codes executed by the methods for processing commodity content provided in the foregoing embodiments.

In implementations, in implementations, the storage medium may be located in any computer terminal in a computer terminal group in a computer network, or located in any mobile terminal in a mobile terminal group.

In implementations, in implementations, the storage medium is configured to store program codes for performing the following operations: identifying design content of at least one partial portion of a product; and identifying at least one feature that is similar to a predetermined design content from the design content of the partial portion of the product; and obtaining at least one alternative content based on the at least one identified feature that is similar to the predetermined design content.

In implementations, in implementations, the storage medium is configured to store program codes for performing the following operations: the method further including: recommending alternative content(s); selecting target alternative content from at least one alternative content, and replacing the design content of the partial portion with the target alternative content.

In implementations, in implementations, the storage medium is configured to store program codes for performing the following operations: prior to replacing the design content of the partial portion with the target alternative content, further including: sending a payment request; and replacing the design content of the partial portion with the target alternative content when a payment associated with the payment request is successfully made.

In implementations, in implementations, the storage medium is configured to store program codes for performing the following operations: identifying at least one feature similar to the predetermined design content from the design content of the partial portion of the product comprising: comparing design features of the design content of the partial portion with design features of the predetermined design content; when a degree of similarity between the design features of the design content of the partial portion and the design features of the predetermined design content exceeds a preset threshold, determining that the design content of the partial portion is similar to the predetermined design content; and identifying at least one feature similar to the predetermined design content from the design content of the partial portion of at least one product.

In implementations, in implementations, the storage medium is configured to store program codes for performing the following operations: determining that the design content of the partial portion is original when the degree of similarity between the design features of the design content of the partial portion and the design features of the predetermined design content does not exceed the preset threshold; and adding the original design content of the partial portion to a traceable database used for storing predetermined design contents.

In implementations, in implementations, the storage medium is configured to store program codes for performing the following operations: identifying at least one feature similar to the predetermined design content from the design content of the partial portion of the product through a recognition algorithm, wherein the design content of the partial portion includes at least one of a pattern, a style, a shape, a color, a text, and a combination thereof.

In implementations, in implementations, the storage medium is configured to store program codes for performing the following operations: after identifying the at least one feature that is similar to the predetermined design content from the design content of the partial portion of the product, including: making a mark on the design content of the partial portion in the design content; and displaying the mark.

In implementations, in implementations, the storage medium is configured to store program codes for performing the following operations: the alternative content belonging to predetermined design contents, and the predetermined design contents being stored in a predetermined database.

In implementations, in implementations, the storage medium is configured to store program codes for performing the following operations: displaying design content of at least one partial portion of a product; displaying at least one feature image of the design content of the partial portion of the product that is similar to a predetermined design content; and displaying alternative content corresponding to the at least one feature image that is similar to the predetermined design content.

In implementations, in implementations, the storage medium is configured to store program codes for performing the following operations: after displaying the alternative content corresponding to the at least one feature image that is similar to the predetermined design content, further including: displaying a payment page of a target alternative content, wherein the target alternative content is selected from the alternative content corresponding to the at least one feature image; and displaying a design content that is obtained after the design content of the partial portion is replaced with the target alternative content, upon a successful payment.

The serial numbers of the embodiments of the present disclosure are merely used for description, and do not represent the advantages and disadvantages of the embodiments.

In the foregoing embodiments of the present disclosure, the descriptions of various embodiments are different, and a part that is not detailed in a certain embodiment can be referenced to related descriptions of other embodiments.

In a number of embodiments provided by the present disclosure, it should be understood that the disclosed technical content may be implemented in other manners. The apparatus embodiments described above are merely illustrative. For example, a division of units is only a division of logical functions. In practical implementations, other manners of division may exist. For example, multiple units or components may be combined or may be integrated into another system, or some features can be ignored or not executed. In addition, a mutual coupling, a direct coupling or a communication connection that is shown or discussed may be an indirect coupling or a communication connection through some interface(s), unit(s) or module(s), and may be an electrical or other form.

The units described as separate components may or may not be physically separated, and the components displayed as units may or may not be physical units, i.e., may be located in a single place, or may be distributed among multiple network units. Some or all of the units may be selected according to actual needs to achieve the purpose of the solutions of the embodiments.

In addition, various functional units in each embodiment of the present disclosure may be integrated into a single processing unit. Alternatively, each unit may exist as an independent entity physically. Alternatively or two or more units may be integrated into a single unit. The above integrated unit can be implemented in a form of hardware or in a form of a software functional unit.

The integrated unit, if implemented in a form of a software functional unit and sold or used as a standalone product, may be stored in a computer readable storage media. Based on such understanding, the essence of the technical solutions of the present disclosure, the parts contributing to the existing technologies, or all or part of the technical solutions may be embodied in a form of a software product. Such computer software product is stored in a storage media, and includes a number of instructions to cause a computing device (which may be a personal computer, a server, or a network device, etc.) to perform all or part of the operations of the methods described in various embodiments of the present application. The storage media includes a U disk, a Read-Only Memory (ROM), a Random Access Memory (RAM), a removable hard disk, a magnetic disk, or an optical disk, etc.

The above description is only exemplary embodiments of the present disclosure. It should be noted that one skilled in the art can also make a number of improvements and modifications without departing from the principles of the present disclosure. These improvements and modifications should be considered as the scope of protection of the present disclosure.

The present disclosure can be further understood using the following clauses.

Clause 1: A product content processing method comprising: identifying design content of at least one partial portion of a product; and identifying at least one feature that is similar to a predetermined design content from the design content of the partial portion of the product; and obtaining at least one alternative content based on the at least one identified feature that is similar to the predetermined design content.

Clause 2: The method of Clause 1, further comprising: recommending alternative content(s); and selecting target alternative content from at least one alternative content, and replacing the design content of the partial portion with the target alternative content.

Clause 3: The method of Clause 2, wherein: prior to replacing the design content of the partial portion with the target alternative content, the method further comprises: sending a payment request; and replacing the design content of the partial portion with the target alternative content when a payment associated with the payment request is successfully made.

Clause 4: The method of Clause 1, wherein identifying at least one feature similar to the predetermined design content from the design content of the partial portion of the product comprises: comparing design features of the design content of the partial portion with design features of the predetermined design content; when a degree of similarity between the design features of the design content of the partial portion and the design features of the predetermined design content exceeds a preset threshold, determining that the design content of the partial portion is similar to the predetermined design content; and identifying at least one feature similar to the predetermined design content from the design content of the partial portion of at least one product.

Clause 5: The method of Clause 4, wherein the design content of the partial portion is determined to be original when the degree of similarity between the design features of the design content of the partial portion and the design features of the predetermined design content does not exceed the preset threshold; and the original design content of the partial portion is added to a traceable database used for storing predetermined design contents.

Clause 6: The method of Clause 1, wherein at least one feature similar to the predetermined design content is identified from the design content of the partial portion of the product through a recognition algorithm, and the design content of the partial portion includes at least one of a pattern, a style, a shape, a color, a text, and a combination thereof.

Clause 7: The method of Clause 1, wherein: after identifying the at least one feature that is similar to the predetermined design content from the design content of the partial portion of the product, the method further comprises: making a mark on the design content of the partial portion in the design content; and displaying the mark.

Clause 8: The method of Clause 1, wherein the alternative content belongs to predetermined design contents, and the predetermined design contents is stored in a predetermined database.

Clause 9: A product content processing method comprising: displaying design content of at least one partial portion of a product; displaying at least one feature image of the design content of the partial portion of the product that is similar to a predetermined design content; and displaying alternative content corresponding to the at least one feature image that is similar to the predetermined design content.

Clause 10: The method of Clause 9, wherein: after displaying the alternative content corresponding to the at least one feature image that is similar to the predetermined design content, the method further comprises: displaying a payment page of a target alternative content, wherein the target alternative content is selected from the alternative content corresponding to the at least one feature image; and displaying a design content that is obtained after the design content of the partial portion is replaced with the target alternative content, upon a successful payment.

Clause 11: A data processing method comprising: obtaining first image data; obtaining second image data of at least one part of the first image data; obtaining at least one feature of the second image data that is similar to a predetermined content; obtaining at least one third image data based on the at least one feature; and replacing the second image data with the third image data to generate resulting data.

Clause 12: The method of Clause 11, wherein: prior to obtaining the at least one feature of the second image data that is similar to the predetermined content, the method further comprises obtaining the predetermined content, the predetermined content being stored in a database.

Clause 13: A product content processing apparatus comprising: a first identification module used for identifying design content of at least one partial portion of a product; a second identification module used for identifying at least one feature that is similar to a predetermined design content from the design content of the partial portion of the product; and an acquisition module used for obtaining at least one alternative content based on the at least one identified feature that is similar to the predetermined design content.

Clause 14: A product content processing apparatus comprising: a first display module used for displaying design content of at least one partial portion of a product; a second display module used for displaying at least one feature image of the design content of the partial portion of the product that is similar to a predetermined design content; and a third display module used for displaying an alternative content corresponding to the at least one feature image that is similar to the predetermined design content.

Clause 15: A storage medium storing a stored program, wherein the program, when being run, controls a device where the storage medium is located to perform the method of any one of Clauses 1-12.

Clause 16: A processing device configured to run a stored program, wherein the program, when being run, performs the method of any one of Clauses 1-12.

What is claimed is:

1. A method implemented by one or more computing devices, the method comprising:
identifying design content of at least one partial portion of a product; and
identifying at least one feature that is similar to a predetermined design content from the design content of the partial portion of the product; and
obtaining at least one alternative content based on the at least one identified feature that is similar to the predetermined design content.

2. The method of claim 1, further comprising:
recommending one or more alternative contents; and
selecting target alternative content from the one or more alternative contents, and replacing the design content of the partial portion with the target alternative content.

3. The method of claim 2, wherein: prior to replacing the design content of the partial portion with the target alternative content, the method further comprises:
sending a payment request; and
replacing the design content of the partial portion with the target alternative content when a payment associated with the payment request is successfully made.

4. The method of claim 1, wherein identifying at least one feature similar to the predetermined design content from the design content of the partial portion of the product comprises:
comparing design features of the design content of the partial portion with design features of the predetermined design content.

5. The method of claim 4, further comprising:
when a degree of similarity between the design features of the design content of the partial portion and the design features of the predetermined design content exceeds a preset threshold, determining that the design content of the partial portion is similar to the predetermined design content; and
identifying at least one feature similar to the predetermined design content from the design content of the partial portion of at least one product.

6. The method of claim 4, further comprising:
determining that the design content of the partial portion is original when the degree of similarity between the design features of the design content of the partial portion and the design features of the predetermined design content does not exceed the preset threshold; and
adding the original design content of the partial portion into a traceable database used for storing predetermined design contents.

7. The method of claim 1, wherein at least one feature similar to the predetermined design content is identified from the design content of the partial portion of the product through a recognition algorithm.

8. The method of claim 1, wherein the design content of the partial portion comprises at least one of a pattern, a style, a shape, a color, a text, and a combination thereof.

9. The method of claim 1, further comprising:
making a mark on the design content of the partial portion in the design content; and
displaying the mark, after identifying the at least one feature that is similar to the predetermined design content from the design content of the partial portion of the product.

10. The method of claim 1, wherein the alternative content belongs to predetermined design contents, and the predetermined design contents is stored in a predetermined data base.

11. An apparatus comprising:
one or more processors; and
memory storing executable instructions that, when executed by the one or more processors, cause the one or more processors to perform acts comprising:
identifying design content of at least one partial portion of a product; and
identifying at least one feature that is similar to a predetermined design content from the design content of the partial portion of the product; and
obtaining at least one alternative content based on the at least one identified feature that is similar to the predetermined design content.

12. The apparatus of claim 11, the acts further comprising:
recommending one or more alternative contents; and
selecting target alternative content from the one or more alternative contents, and replacing the design content of the partial portion with the target alternative content.

13. The apparatus of claim 12, wherein: prior to replacing the design content of the partial portion with the target alternative content, the acts further comprise:
sending a payment request; and
replacing the design content of the partial portion with the target alternative content when a payment associated with the payment request is successfully made.

14. The apparatus of claim 11, wherein identifying at least one feature similar to the predetermined design content from the design content of the partial portion of the product comprises:
comparing design features of the design content of the partial portion with design features of the predetermined design content.

15. The apparatus of claim 14, the acts further comprising:
when a degree of similarity between the design features of the design content of the partial portion and the design features of the predetermined design content exceeds a preset threshold, determining that the design content of the partial portion is similar to the predetermined design content; and
identifying at least one feature similar to the predetermined design content from the design content of the partial portion of at least one product.

16. The apparatus of claim 14, the acts further comprising:
determining that the design content of the partial portion is original when the degree of similarity between the design features of the design content of the partial portion and the design features of the predetermined design content does not exceed the preset threshold; and
adding the original design content of the partial portion into a traceable database used for storing predetermined design contents.

17. The apparatus of claim 11, wherein at least one feature similar to the predetermined design content is identified from the design content of the partial portion of the product through a recognition algorithm, and the design content of the partial portion comprises at least one of a pattern, a style, a shape, a color, a text, and a combination thereof.

18. The apparatus of claim 1, the acts further comprising:
making a mark on the design content of the partial portion in the design content; and
displaying the mark, after identifying the at least one feature that is similar to the predetermined design content from the design content of the partial portion of the product.

19. One or more computer readable media storing executable instructions that, when executed by one or more processors, cause the one or more processors to perform acts comprising:
obtaining first image data;
obtaining second image data of at least one part of the first image data;
obtaining at least one feature of the second image data that is similar to a predetermined content;
obtaining at least one third image data based on the at least one feature; and
replacing the second image data with the third image data to generate resulting data.

20. The one or more computer readable media of claim 19, the acts further comprising obtaining the predetermined content prior to obtaining the at least one feature of the second image data that is similar to the predetermined content, the predetermined content being stored in a database.
